(19) United States
(12) Patent Application Publication
(10) Pub. No.: US 2024/0202309 A1
(43) Pub. Date: Jun. 20, 2024

(54) SYSTEMS AND METHODS FOR VALIDATION OF SECURITY CODE REQUISITE COMPONENT CHARACTERS

(71) Applicant: Truist Bank, Charlotte, NC (US)

(72) Inventors: Brian Stewart Brown, Apex, NC (US); Jonathan Randall Howarth, Raleigh, NC (US); Earlie Clark, IV, Wake Forest, NC (US); Thomas Prescott Atherton, Atlanta, GA (US); Szu yu Zoe Chao, Cary, NC (US)

(73) Assignee: Truist Bank, Charlotte, NC (US)

(21) Appl. No.: 18/066,346

(22) Filed: Dec. 15, 2022

(51) Int. Cl. G06F 21/45

(52) U.S. Cl. CPC G06F 21/45

(57) ABSTRACT

In systems, methods, and devices for real time fulfillment validation of security code requisite component characters includes a security code is maintained for each user of multiple registered users each having one or more user device, the security code being required for authorizing access by the user to at least one product, service, or content. For resetting of the security code of a user, a fulfillment validation tool displays an entry field showing ordered characters of a received new security code as they are entered by the user, a listing of requisite components required of a new security code, and graphical indicators each associated with a respective particular one of the requisite components. Each graphical indicator transitions upon fulfillment of the particular one of the requisite components by at least one character of the received new security code in real time as said characters are entered by the user.

### TECHNICAL FIELD

The present disclosure relates to computer network security. More particularly, the present disclosure relates to improving security code requirement fulfillment.

### BACKGROUND

Consumers are increasingly conducting business and exchanging private information online. Information and account security is of utmost importance for consumer confidence and business success. Whether accessing financial accounts, socializing, or enjoying streaming media, businesses, social media sites, and content providers are expected to maintain account information private and secure, especially given that many sites require membership fees, which may be periodic, and of course online merchants require payment for purchases. Thus many of the of the websites and entities with which consumers interact have records of payments and payment vehicles such as account numbers, credit card numbers, and other crucial data related to funds and/or other resources.

Users are typically required to have passwords to access accounts and information, and in order to thwart unauthorized access by hackers and bad actors, administrators often require some minimum complexity in choosing passwords, and the often require password changes periodically, upon a failed entry attempt by a user, or upon a detected hacking event.

Consumers are often frustrated by password requirements, for which little feedback is provided other than the basic result that a proposed new password does not meet minimum security requirements.

Improvements are needed for conveniently affirming what password requirements are fulfilled and what requirements are not met when a password reset is attempted.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

According to at least one embodiment, a system for real time fulfillment validation of security code requisite component characters includes a computing system having one or more processor configured to execute computer-readable instructions, and at least one of a memory device and a non-transitory storage device maintaining a security code for each user of multiple registered users each having one or more user device, the security code being required for authorizing access by the user to at least one product, service, or content. A network connection operatively connects the computing system to user devices of the multiple registered users. Upon execution of the computer-readable instructions, the computing system performs steps including, for a specific user of the multiple registered users upon an event prompting resetting of the security code of the specific user, causing display, by a user device of the specific user, of a fulfillment validation tool. The validation tool includes an entry field displaying ordered characters of a received new security code as said ordered characters are entered by the specific user, a listing of requisite components each applicable to at least one character of the received new security code, and graphical indicators each associated with a respective particular one of the requisite components. Each graphical indicator transitions upon fulfillment of the particular one of the requisite components by at least one character of the received new security code in real time as said characters are entered by the specific user.

In at least one example, each graphical indicator transitions upon fulfillment of the particular one of the requisite components agnostic of the order in which said ordered characters are entered by the specific user.

Each graphical indicator transitioning may include displaying at least one of a symbol and a color change.

The listing of requisite components can include a requirement for each of a minimum number of characters, at least one uppercase letter, at least one lower case letter, a number and a symbol, the symbol being non-alphabetic and non-numeric.

Causing display, by a user device of the specific user, of a fulfillment validation tool may further include determining, as each one character of said ordered characters is entered by the specific user, whether said one character fulfills any of said component requirements.

Each transitioned graphical indicator may remain transitioned as long as at least one character fulfills the particular one of the requisite components associated with the transitioned graphical indicator.

Causing display, by a user device of the specific user, of a fulfillment validation tool may include using a design system token.

The design system token may be compatible with a screen reader for outputting to a speech synthesizer or braille display.

According to at least one embodiment, to which the above examples apply as well, a system for real time fulfillment validation of security code requisite component characters includes one or more processor configured to execute computer-readable instructions, and at least one of a memory device and a non-transitory storage device maintaining data and a security code required for authorizing access to the data. Upon execution of the computer-readable instructions, the one or more processor performs steps comprising, upon an event prompting resetting of the security code, causing display to a user, of a fulfillment validation tool. The validation tool includes an entry field displaying ordered characters of a received new security code as said ordered characters are entered by the user, a listing of requisite components each applicable to at least one character of the received new security code, and graphical indicators each associated with a respective particular one of the requisite components. Each graphical indicator transitions upon fulfillment of the particular one of the requisite components by at least one character of the received new security code in real time as said characters are entered by the user.

According to at least one embodiment, a method is provided for a computing system to conduct real time fulfillment validation of security code requisite component characters. The computing system includes one or more processor, and at least one of a memory device and a non-transitory storage device. A network connection is configured for operatively connecting the computing system to user devices of the multiple registered users. The at least one of a memory device and a non-transitory storage device maintain a security code for each user of multiple registered users, the security code being required for authorizing access by the user to at least one product, service, or content. The one or more processor is configured to execute computer-readable instructions. The method includes, upon execution of the computer-readable instructions, and upon an event prompting resetting of the security code for a specific user of the multiple registered users, causing display, by a user device of the specific user, of a fulfillment validation tool. The validation tool includes an entry field displaying ordered characters of a received new security code as said ordered characters are entered by the specific user, a listing of requisite components each applicable to at least one character of the received new security code, and graphical indicators each associated with a respective particular one of the requisite components. Each graphical indicator transitions upon fulfillment of the particular one of the requisite components by at least one character of the received new security code in real time as said characters are entered by the specific user.

The above summary is to be understood as cumulative and inclusive. The above described embodiments and features are combined in various combinations in whole or in part in one or more other embodiments.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 illustrates an enterprise system and environment thereof for at least real time fulfillment validation of security code requisite component characters, in accordance with various embodiments of the present invention.

FIG. 2 illustrates the display of a validation tool and its elements according to at least one embodiment.

FIG. 3 illustrates the display of the validation tool of FIG. 2, shown with characters typed into the entry field by a user.

FIG. 4 illustrates the display of the validation tool with typed characters submitted as a proposed security code and a feedback indicator reporting insufficiency with regard to one or more requisite component.

FIG. 5 illustrates the display of the validation tool with all shown graphical indicators have transitioned indicating sufficiency of typed characters as a security code according to all shown requisite components.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

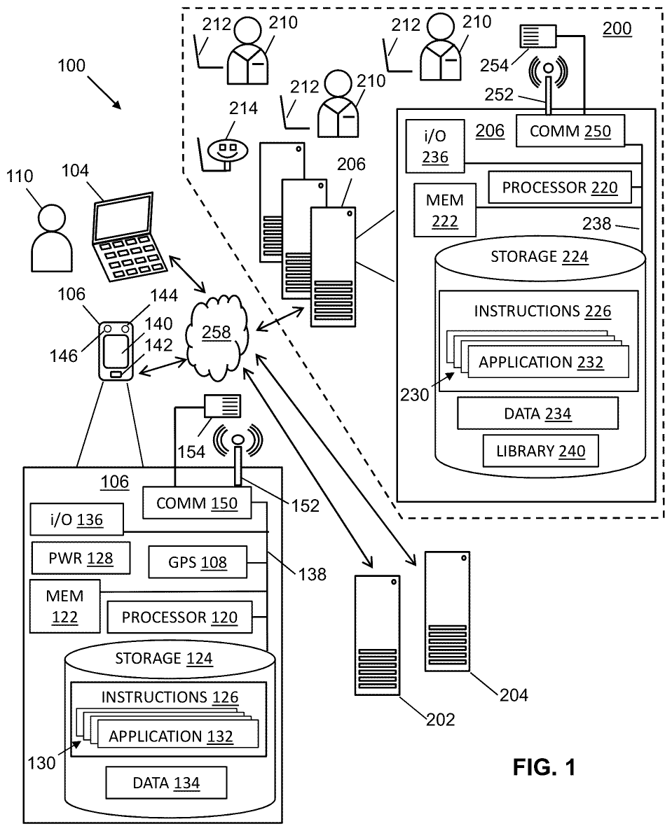

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The above-described devices and systems are utilized in implementing reusable user interface (UI) components, in some embodiments. Once constructed, the user interface components can be used in various programs and applications, being available for example in an open-source library. High-level utility is found at least in time savings for program development and brand identification as proprietary design specifics are shared among software coders and developers of an enterprise entity. At the functional level, each example described here and those that come to mind in view of these descriptions serve specific functions for both user and developer convenience.

Consistency in choices of interface elements fosters user familiarity, providing elements acting in a particular way. Choosing to adopt consistent elements can help on both the enterprise side and user side with task completion, efficiency, and satisfaction.

Typical interface elements include, but are not limited to, input controls, navigational components, and information components. Typical input controls include, but are not limited to, checkboxes, radio buttons, dropdown lists, list boxes, buttons, toggles, text fields, and date field. Typical navigational components include, but are not limited to breadcrumbs, sliders, search fields, paginations, tags, and icons. Typical informational components include, but are not limited to, tooltips, icons, progress bars, notifications, message boxes, and modal windows. These terms delineating, for descriptive purposes, typical interface elements as input controls, navigational components, and information components are offered here for an understanding of context and use of the described inventive embodiments, without limiting those embodiments to such characterizations. In some cases an interface element may be characterized as more than one these types, such that not all such characterizations will be universally agreed upon, and in some cases, these terms may be used interchangeably.

The inventive interface elements described herein can be characterized as well as design system tokens, which implement style values of UI elements, values that govern color, typography, spacing, shapes, shadows, and the like. Once established, the token can be used across products and are capable of being converted or mapped into the format for any platform (web, angular, mobile, desktop, IOS, Android, etc.). Tokens can be taken by front end developers in referencing things within a design system and automatically inserted into or utilized by front end code. Tokens allow for keeping consistency through an app delivering things without having to do updates within the app side code for development.

Within a company or other organization, for example, a design system improves collaboration between product teams. A common challenge design and engineering teams are facing is the sharing of brand guidelines and interface information across the institution they serve. Designs once developed should be respected for efficiency and consistency. Product teams need guidelines to ensure brand consistency. This is where style guides and pattern libraries come into play, as implemented by tokens in some cases.

An advantageous aspect of inventive interface elements described herein regards compatibility and with screen readers, which are software programs that allow blind or visually impaired users to read text that is displayed on a screen with, for example, a speech synthesizer or braille display. A screen reader serves as an interface between the computer's operating system, its applications, and the user. Commands are sent by the user pressing key combinations on the keyboard or braille display to prompt the synthesizer and/or braille display what to say and/or output automatically when changes do or would otherwise occur on a computer screen. A command can instruct the synthesizer and/or braille display to read or spell a word, read a line or full screen of text, find a text string, announce the location of a cursor or focused item, and so on. Users can perform advanced functions, such as locating items such as text and/or icons displayed in any particular color, indicating a color change, and reading pre-designated parts of a screen on demand, reading highlighted text, and identifying an active choice in a menu. Users may also use a spell checker or read the cells of a spreadsheet with a screen reader or braille display. Screen readers are currently available for use with personal computers running Linux, Windows, and Mac, IOS, Android, and more, and the inventive interface elements described herein are compatible and configured for use with same.

Display, displaying, causing to display, causing display, and similar terms in these descriptions refer at least to visible presentations on user devices and/or agent devices. These and similar terms also refer to virtual reality (VR) presentations, augmented reality (AR) presentations. These and similar terms also refer to the effected outputs of screen readers, which may be audible, and braille displays, which may at least in part be mechanical and/or tactile.

In some inventive embodiments described herein, a first entity and/or enterprise entity herein provides financial services and operates as a financial institution. The first entity may be previously and currently engaging a user in a range of services such as checking, credit card, debit card, mortgage, and savings account services. In such cases, where the user is a highly engaged client, the service entity has direct access to data regarding credit cards, checking, savings, and other financial arrangements and means. In such examples and others, the first entity maintains account records, each associated with a respective one of multiple user entities, for example as represented in FIG. 1 as data 234, which can include, as non-limiting examples, cached data, and files such as those for user accounts, user profiles, account balances, and transaction histories.

For security and confidentiality purposes, account records are generally secured from unauthorized access. Thus, the account records of a particular user are inaccessible without user authentication. However, even prior to or without such authentication, an agent or system of the first entity may conduct a communication session and provide information, for example, about multiple services made available at least in part by the first entity. In examples of the first entity and/or enterprise entity providing financial services and/or operating as a financial institution, the services made available and for which information can be disseminated prior to or without user authentication can include, as non-limiting examples, policies and offerings for checking, credit card, debit card, mortgage, and savings account services, and the information disseminated can be provided without specific user account details in the absence of user authentication.

The account records of a particular user, in some examples, are made accessible to the user during a bidirectional communication session upon user authentication by the user. For example, a username and password implemented as a security code may be provided to satisfy user authentication and/or further security measures may be applied. Upon user authentication, user access to accounts and actions may be permitted such as balance requests, funds transfers, funds conversions, and other information access and action regarding user owned or user associated assets.

A security code in some implementations within the scope of these descriptions must meet certain prescribed minimum requirements in order to assure information and account security and to thwart unauthorized access by hackers and bad actors. Thus, a minimum number of characters and certain components may be required of the security code characters. For example, a minimum number of characters, at least one uppercase letter, at least one lower case letter, at least one number and at least one symbol, the symbol being non-alphabetic and non-numeric, may be required. Such security code requisite component characters increase the strength of a security code by decreasing the likelihood of a successful guess and the likely number of attempts that would be required for an automated hacking tool to find success, increasing the time required and also the likelihood of detection.

With these considerations in mind, not only are security code requisite component characters advantageous for information and account security, a security code can be changed or reset, for example on a schedule by which existing or old security codes expire or upon some other occurrence, such as a detected hacking attempt or a user reporting the compromise of data, equipment, or belongings. In some cases, for example, a user may have forgotten a security code, and has requested assistance recovering account access. Thus, upon such or some events, whether regularly scheduled or otherwise, the resetting of the security code of one or more specific user may be required, suggested, or beneficial, and thus prompted.

Prior schemes, for resetting passwords for example, entailed a user proposing a new password by entry of the proposed in its entirety, upon which entry an automated check was conducted to determine whether minimum requirements are met. This is disadvantageous with regard to the time and frustration level of a user attempting to vet new proposed passwords against the requirements. For example, as the user types, no immediate feedback is provided by which to supplement or change characters being entered as part of a proposed new password. The user in some situations having failed to meet password requirements is informed only of the failure, not the nature of the shortcoming of the proposed new password in relation to each requirement set forth for successful password change.

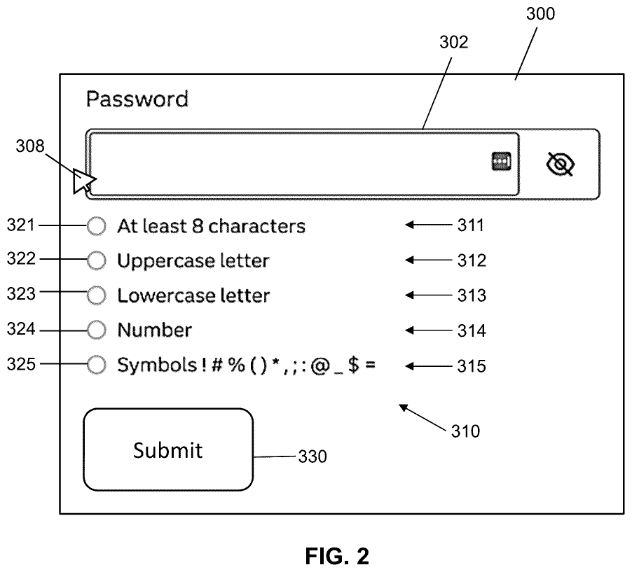

Thus systems, devices, and methods are described herein for real time fulfillment validation of security code requisite component characters. Such systems, devices, and methods can be implemented with or as a validation tool, an embodiment of use and/or display of which is shown in FIGS. 2-5, which together illustrate and exemplify an ordered sequence of user actions and the effective response by the validation tool to those user actions. Inventive aspects of the systems, devices, and methods are described herein improve the functioning of computer systems and networks by increasing the security of same against hacking and fraudulent access, thus better securing stored content and thwarting unauthorized transactions, loss of data and other resources.

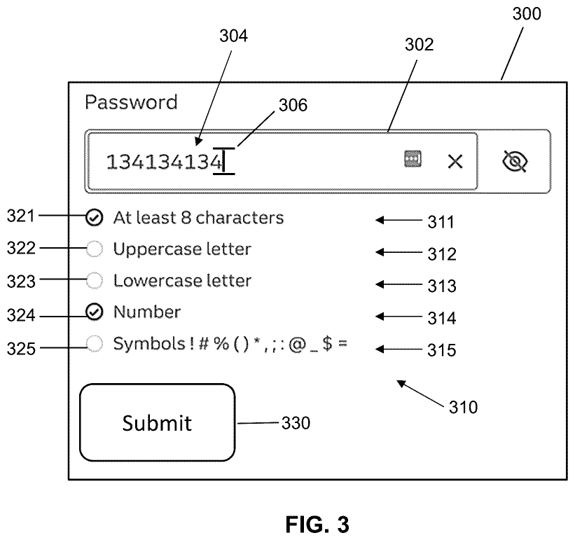

FIG. 2 illustrates the display of the validation tool 300 and its elements. The validation tool includes an entry field 302 for displaying ordered characters of any received new security code as said ordered characters are entered by the specific user. Characters typed into the entry field 302 throughout FIGS. 3-5 are referenced consistently as characters 304 for convenience in the drawings even as they vary according to user inputs as described below.

A listing 310 of requisite components each applicable to at least one character of any received new security code appears below the entry field 302 in the design of the validation tool 300 shown in the drawings, although other arrangements and designs are within the full scope of these description taken in their full breadth.

In illustrated example, a first requisite component 311 is shown for example as requiring a minimum count of characters, at least eight characters in particular, of any new proposed security code. A second requisite component 312 is shown for example as requiring a minimum count of uppercase letters, in particular at least one, of any new proposed security code. A third requisite component 313 is shown for example as requiring a minimum count of lowercase letters, in particular at least one, of any new proposed security code. A fourth requisite component 314 is shown for example as requiring a minimum count of numbers, in particular at least one number referring to Arabic numerals 0-9 in some implementations, of any new proposed security code. A fifth requisite component 315 is shown for example as requiring, at least one symbol, the symbol being non-alphabetic and non-numeric, of any new proposed security code. The at least one symbol for example may be among those available on typical keyboards and such, including such examples as those punctuation marks shown. These first through fifth requisite components are provided as non-limiting examples.

Graphical indicators are shown in FIG. 2, each associated with a respective particular one of the requisite components. Each graphical indicator transitions upon fulfillment of the particular one of the requisite components by at least one character of the received new security code in real time as said characters are entered by the specific user. The graphical indicators are shown as aligned with their respectively associated requisite components for intuitive recognition of their association. That is, in FIG. 2, a first graphical indicator 321 is shown associated with the first requisite component 311. Similarly a second graphical indicator 322 is shown associated with the second requisite component 312, a third graphical indicator 323 is shown associated with the third requisite component 313, a fourth graphical indicator 324 is shown associated with the fourth requisite component 314, and a fifth graphical indicator 325 is shown associated with the fifth requisite component 315.

In the illustrated display of the validation tool 300 and its elements of FIGS. 2-5, the graphical indicators are provided to confirm fulfillment of their respective associated requisite components in real time as characters 304 are entered into the entry field 302 by a user intending to propose a new security code. Each particular graphical indicator, upon fulfillment of the particular one of the requisite components with which it is associated by at least one character of the received new security code, transitions in real time as said characters 304 are entered by the user. That is, upon a character typed into the entry field 302 by the user fulfilling any one requisite component, the graphical indicator associated with that requisite transitions to confirm such fulfillment. Thus, even as the user types, the user is made aware of which requisite components are fulfilled and which requisite components remained to be fulfilled by typing further characters or replacing those already typed.

FIG. 3 illustrates the display of the validation tool 300 and its elements exemplified in FIG. 2, shown with characters typed into the entry field 302 by a user. In the illustrated example, the first graphical indicator 321 and fourth graphical indicator 324 have transitioned indicating fulfillment of the respectively associated first requisite component 311 and fourth requisite component 314. In the illustrated example of the validation tool 300, a graphical indicator transitions by displaying a symbol and a color change. The graphical indicators in the drawings are shown as circular areas defined by boundary rings, each of which can have a color as seen on a color display such as that of a computing device, such as a user device, referring to either or both of the computing device 104 and the mobile device 106 in some examples. In FIG. 3, the circular area of each of the first graphical indicator 321 and fourth graphical indicator 324 are each populated with a respective symbol, in particular a check mark as a non-limiting example, indicating transition and, and accordingly fulfillment of the associated first requisite component and fourth requisite component. Furthermore in FIG. 3, the boundary rings of the first graphical indicator 321 and fourth graphical indicator 324 can each transition, for example from black or grey to green, other color, when a color display is used, further affirming fulfillment of the associated first requisite component 311 and fourth requisite component 314.

These transitions have occurred ahead of the user submitting the proposed security code represented by the typed characters 304 in the entry field 302, as represented by the position marker 306 continuing to hover in the entry field 302 in FIG. 3. Each graphical indicator transitions upon fulfillment of the particular one of the requisite components agnostic of the order in which said ordered characters are entered by the specific user. Accordingly, in the example of FIG. 3, the fourth graphical indicator 324 will have transitioned as the first digit “1” was typed into the entry field 302, ahead of the first graphical indicator 321 transitioning upon the eighth digit being typed. Thus, the graphical indicators transition in the order in which their associated requisite components are fulfilled.

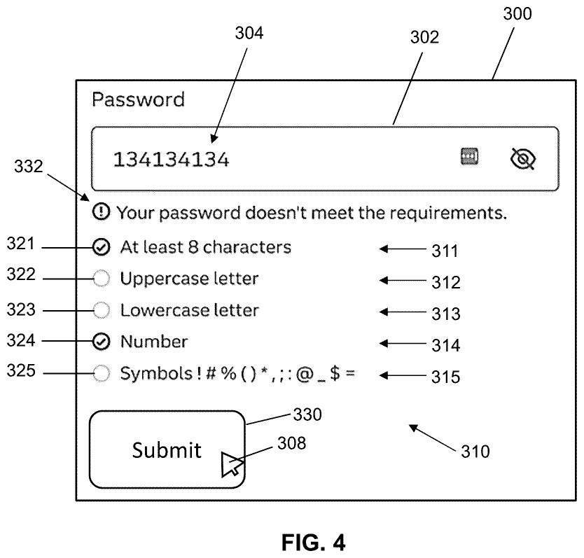

Actual submission of the proposed security code in the entry field 302 has occurred in FIG. 4, for example by use of the cursor 308 at the submit box 330 and a click or other entry indication. A feedback indicator 332 appears upon submission of an insufficient proposed security code as shown as a message in the illustrated example as “Your password doesn't meet the requirements.” A user at this stage, having attempted a submission, is informed of insufficiency overall by the feedback indicator 332, and the nature of the insufficiency by the non-transitioned second graphical indicator 322, third graphical indicator 323, and fifth graphical indicator 325. The user remains informed, at this stage (FIG. 4) of which requisite components are fulfilled by the first graphical indicator 321 and fourth graphical indicator 324, each of which remains transitioned as long as at least one character within the entry field 302 fulfills the particular one of the requisite components associated with the transitioned graphical indicator.

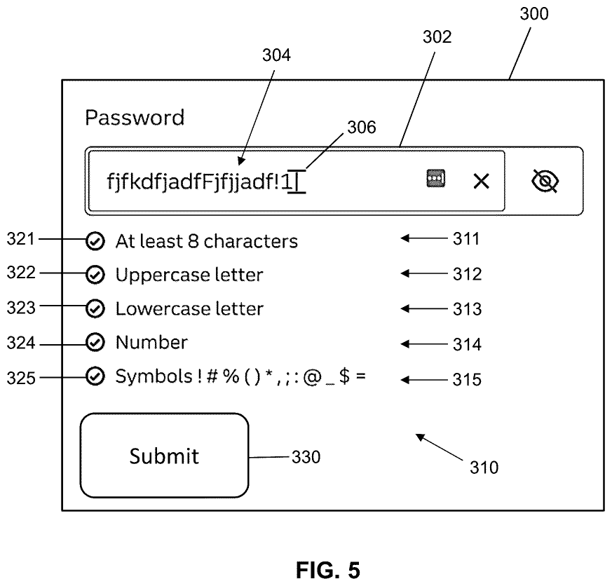

In FIG. 5, the user has typed further characters 304 into the entry field 302, and the each of the five illustrated graphical indicators 321-325 have transitioned, representing fulfillment of the five requisite components 311-315, prior to the use necessarily of the submit box 330 as represented by the by the position marker 306 continuing to hover in the entry field 302 in FIG. 5. This visually demonstrates in the drawings the real time fulfillment validation, as the user types in the entry field 302, of security code requisite component characters by the fulfillment validation tool 300.

Further action by the user, for example by use of the submit box and a click or other entry indication, will prompt a security code update, for example on the user device under use and/or on other systems and devices as represented for example in FIG. 1.

According to the above descriptions, in various embodiments and for at least one example, the system 200 provides for real time fulfillment validation of security code requisite component characters. In at least one other example, devices represented in FIG. 1 as user devices 104 and 106 serve in conjunction with and/or independently from the system 200 for real time fulfillment validation of security code requisite component characters.

At least one of a memory device 222 and a non-transitory storage device 224, in some embodiments, maintains account records for each of multiple registered users, each having at least one user device. The network connection 258 can operatively connect the computing system 206 to the user devices of the multiple registered users, with reference as non-limiting examples to user 110 and devices represented in FIG. 1 as user devices 104 and 106. The validation tool 300 described and illustrated herein may be effectively a display output on a user device from a software program or portion thereof running an enterprise side with, reference to system 200 and the processing device 220, such that the system 200 at least in part remotely controls or contributes to a display at a user device across a network. The display of the validation tool 300 and its function can be effected using a design system token, for example which may be available system-wide, referring to the enterprise system 200, in a source library 240 (FIG. 1) where various programs and applications are available to administrators, agents, and the computing systems 206. The design system token described and/or other software implementations of the validation tool 300 described herein is in some examples compatible with screen readers for outputting to a speech synthesizer or braille display.

In some embodiments, the validation tool 300 is effected by a software program or portion thereof running and/or available at external systems 202 and 204 (FIG. 1). In yet other embodiments, the validation tool is effected by a software program or portion thereof running on a user device. For example, a design system token or other software program or code may be stored upon and disseminated from the library 240 and/or other libraries, folders, or files resident at user devices and/or external systems.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A system for real time fulfillment validation of security code requisite component characters,
the system comprising:
a computing system including one or more processor configured to execute computer-readable instructions, and at least one of a memory device and a non-transitory storage device maintaining a security code for each user of multiple registered users each having one or more user device, the security code being required for authorizing access by the user to at least one product, service, or content;
a network connection for operatively connecting the computing system to user devices of the multiple registered users;
wherein, upon execution of the computer-readable instructions, the computing system performs steps comprising, for a specific user of the multiple registered users upon an event prompting resetting of the security code of the specific user:
causing display, by a user device of the specific user, of a fulfillment validation tool comprising:
an entry field displaying ordered characters of a received new security code as said ordered characters are entered by the specific user;
a listing of requisite components each applicable to at least one character of the received new security code; and
graphical indicators each associated with a respective particular one of the requisite components, each graphical indicator transitioning upon fulfillment of the particular one of the requisite components by at least one character of the received new security code in real time as said characters are entered by the specific user.

2. The system according to claim 1, wherein each graphical indicator transitions upon fulfillment of the particular one of the requisite components agnostic of the order in which said ordered characters are entered by the specific user.

3. The system according to claim 1, wherein each graphical indicator transitioning comprises displaying at least one of a symbol and a color change.

4. The system according to claim 1, wherein the listing of requisite components comprises a requirement for each of a minimum number of characters, at least one uppercase letter, at least one lower case letter, a number and a symbol, the symbol being non-alphabetic and non-numeric.

5. The system according to claim 1, wherein causing display, by a user device of the specific user, of a fulfillment validation tool further comprises determining, as each one character of said ordered characters is entered by the specific user, whether said one character fulfills any of said component requirements.

6. The system according to claim 5, wherein each transitioned graphical indicator remains transitioned as long as at least one character fulfills the particular one of the requisite components associated with the transitioned graphical indicator.

7. The system according to claim 1, wherein causing display, by a user device of the specific user, of a fulfillment validation tool comprises using a design system token.

8. The system according to claim 7, wherein the design system token is compatible with a screen reader for outputting to a speech synthesizer or braille display.

9. A system for real time fulfillment validation of security code requisite component characters, the system comprising:
one or more processor configured to execute computer-readable instructions, and at least one of a memory device and a non-transitory storage device maintaining data and a security code required for authorizing access to the data;
wherein, upon execution of the computer-readable instructions, the one or more processor performs steps comprising, upon an event prompting resetting of the security code:
causing display to a user, of a fulfillment validation tool comprising:
an entry field displaying ordered characters of a received new security code as said ordered characters are entered by the user;
a listing of requisite components each applicable to at least one character of the received new security code; and
graphical indicators each associated with a respective particular one of the requisite components, each graphical indicator transitioning upon fulfillment of the particular one of the requisite components by at least one character of the received new security code in real time as said characters are entered by the user.

10. The system according to claim 9, wherein each graphical indicator transitions upon fulfillment of the particular one of the requisite components agnostic of the order in which said ordered characters are entered by the user.

11. The system according to claim 9, wherein each graphical indicator transitioning comprises displaying at least one of a symbol and a color change.

12. The system according to claim 9, wherein causing display to a user of a fulfillment validation tool comprises using a design system token.

13. The system according to claim 9, wherein the listing of requisite components comprises a requirement for each of a minimum number of characters, at least one uppercase letter, at least one lower case letter, a number and a symbol, the symbol being non-alphabetic and non-numeric.

14. The system according to claim 9, wherein causing display to a user device of a fulfillment validation tool further comprises determining, as each one character of said ordered characters is entered by the user, whether said one character fulfills any of said component requirements.

15. The system according to claim 14, wherein each transitioned graphical indicator remains transitioned as long as at least one character fulfills the particular one of the requisite components associated with the transitioned graphical indicator.

16. A method for a computing system to conduct real time fulfillment validation of security code requisite component characters, the computing system including one or more processor, at least one of a memory device and a non-transitory storage device, and a network connection for operatively connecting the computing system to user devices of the multiple registered users, the at least one of a memory device and a non-transitory storage device maintaining a security code for each user of multiple registered users, the security code being required for authorizing access by the user to at least one product, service, or content, the one or more processor configured to execute computer-readable instructions, the method comprising, upon execution of the computer-readable instructions:
upon an event prompting resetting of the security code for a specific user of the multiple registered users, causing display, by a user device of the specific user, of a fulfillment validation tool comprising:
an entry field displaying ordered characters of a received new security code as said ordered characters are entered by the specific user;
a listing of requisite components each applicable to at least one character of the received new security code; and
graphical indicators each associated with a respective particular one of the requisite components, each graphical indicator transitioning upon fulfillment of the particular one of the requisite components by at least one character of the received new security code in real time as said characters are entered by the specific user.

17. The method according to claim 16, wherein each graphical indicator transitions upon fulfillment of the particular one of the requisite components agnostic of the order in which said ordered characters are entered by the specific user.

18. The method according to claim 16, wherein each graphical indicator transitioning comprises displaying at least one of a symbol and a color change.

19. The method according to claim 16, wherein the listing of requisite components comprises a requirement for each of a minimum number of characters, at least one uppercase letter, at least one lower case letter, a number and a symbol, the symbol being non-alphabetic and non-numeric.

20. The method according to claim 16, wherein each transitioned graphical indicator remains transitioned as long as at least one character fulfills the particular one of the requisite components associated with the transitioned graphical indicator.
